(19) United States
(12) Patent Application Publication
(10) Pub. No.: US 2011/0103008 A1
(43) Pub. Date: May 5, 2011

(54) Fan Control System and Method for a Computer System Available at Different Altitudes

(75) Inventors: Ameha Aklilu, Taipei (TW); Ku-Jei King, Taipei (TW); Edward Yu-Chen Kung, Taipei (TW); Ian Lin, Taipei (TW); Ming-Hui Pan, Taipei (TW)

(73) Assignee: International Business Machines Corporation, Armonk, NY (US)

(21) Appl. No.: 12/908,957

(22) Filed: Oct. 21, 2010

(30) Foreign Application Priority Data
Oct. 30, 2009 (TW) 098137240

(51) Int. Cl. G06F 1/20; G05D 23/00

(52) U.S. Cl. 361/679.48; 700/300

(57) ABSTRACT

A fan control system for a computer system at the different altitudes is provided. The fan control system includes a current detector and a controller. The current sensing circuit detects a current of a fan at full speed. The controller outputs a control signal for controlling the fan within the computer system according to the fan current.

### TECHNICAL FIELD

The present invention relates to a fan control system and method for a computer system available at the different altitudes.

### BACKGROUND OF THE INVENTION

Generally, a computer system, for example a personal computer or high-end server, will have a cooling fan installed inside the system for heat dissipation. Particularly, for the existed central processing unit (CPU) or storage device, such as memory or hard disk, due to the increased processing speed and correspondingly the resulting high temperature. It is further required for employing a cooling fan to enhance the effect of heat dissipation to prevent the system damage due to being overheated. As the altitude of position where the computer system is located changes, the air density is changing so as to influence the cooling efficiency. Now, the computer system is designed for 7000 ft or much higher. Accordingly, the fan speeds of the present fan speed control are determined based on the assumption that the computer system will operate normally at the highest altitude such as 7000 ft or much higher from the sea level. The fan needs to ramp up to keep the same mass flow rate on the control volume point of view, for the air turns to be less dense. This results in a fan speed higher than the necessary fan speed when the computer system is used at lower altitudes, and thus increases noise and power consumption.

There is one kind of conventional fan which can monitor the fan speed, and compensate it when the fan speed is under or over an estimated value. However, the fan cannot be applied to different altitudes. Another solution is to use a pressure sensor (as an altitude sensor), such as Bosch BMP085, so that the fan speed control can be accurately adjusted for the altitude effect. However, it will cause more money to implement the sensor.

There is needed a computer system which operates normally without a pressure sensor at the different altitudes so as to remove extra cost and achieve the effect of energy saving at the same time.

### SUMMARY OF INVENTION

In one aspect, a fan control system and method is provided for a computer system to operate normally without a pressure sensor at the different altitudes so as to remove extra cost and achieve the effect of energy saving at the same time. Another aspect provides a fan control system and method to reduce the noise by the fan when the computer system is used at lower altitudes.

In another aspect, a computer system is provided with a target device, a fan for providing airflow to the target device, and a fan control system for controlling the fan. The fan control system further comprises a current detector and a controller, in which the current detector is configured for detecting a current of the fan at full speed, and the controller generates a control signal for controlling the fan at least according to the current of the fan. The fan may be a fan controlled by a PWM (Pulse-width modulation) signal.

In yet another aspect, a fan control method for a computer system which comprises a fan for providing airflow to a target device is provided. The method detects a current of the fan at full speed, and generates a control signal for controlling the fan according to the current of the fan.

The features, advantages and similar expressions disclosed in this specification do not mean that all the features and advantages realized by the present invention should be within any single embodiment of the present invention. It should be noted that the expressions regarding to the features and advantages indicate those specific features, advantages or characteristics described in connection with embodiments are included in at least one embodiment of the present invention. Therefore, the descriptions regarding to the features, advantages and similar expressions in the specification are related to the similar embodiments, but not necessarily.

These features and advantages can be further understood by referring to the description below and attached claims or using the Detailed Description of the present invention described below.

### BRIEF DESCRIPTION OF DRAWINGS

In order to immediately understand the advantages of the present invention, please refer to the specific embodiments shown in the drawings, which describe in details the present invention in a brief description above. It should be noted that these drawings only describe the typical embodiments of the present invention, and should not be considered as limiting the scope of the present invention. The present invention is described by referring the drawings and additional specifics and details, in which:

FIG. 1 shows a computer system according to an embodiment of the present invention.

FIG. 2 shows a flow diagram for a fan control method of the present invention, which describes the present invention in connection with FIG. 1.

FIG. 3(a) is a diagram showing a relationship of currents versus altitudes for two same kind of fans (i.e. No. 1 & No. 2) operating at 25° C., and a relationship of the average current (i.e. Average) of the two same fans versus altitude at 25° C. FIG. 3(b) is a diagram showing a relationship of the average currents of fans operating at the different temperatures (e.g. 25° C., 55° C. and −40° C.) versus altitudes.

### DETAILED DESCRIPTION OF PREFERRED EMBODIMENTS

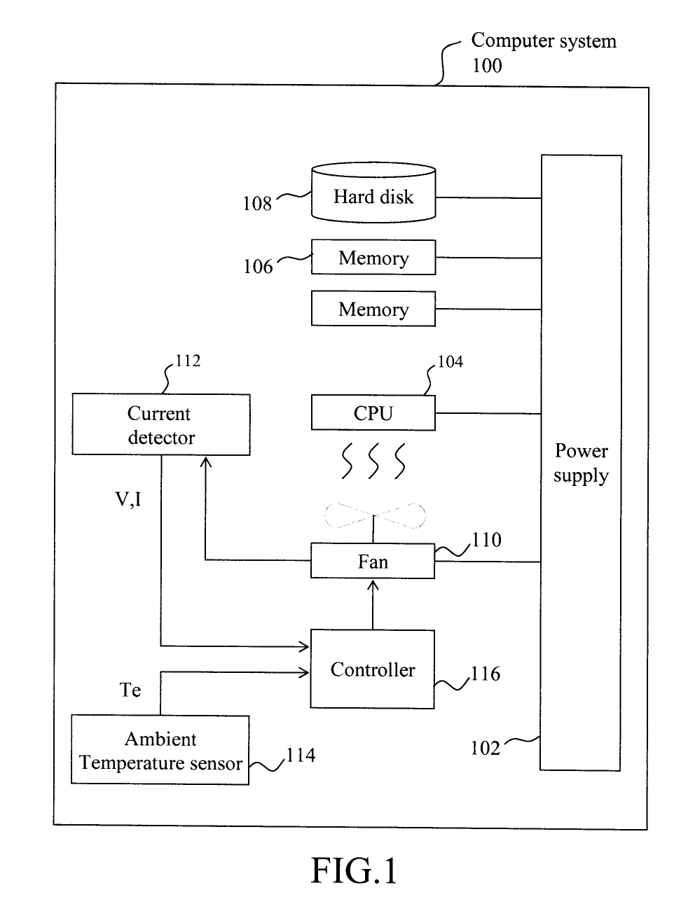

FIG. 1 shows hardware architecture of a computer system 100 in an embodiment, which comprises a power supply 102, a CPU 104, a memory 106, a hard disk 108, a fan 110, a current detector 112, an ambient temperature sensor 114, and a controller 116. Other basic architectures and components for computer system 100 may be referred to an ordinary personal computer or server, such as System X®, Blade Center® or eServer® server from IBM Corporation. The details not related to the present invention will be omitted without description.

When a computer system 100 is operating, the power supply 102 provides direct current (DC) power to CPU 104, memory 106, hard disk 108, and a fan 110. It should be noted that the memory 106, the hard disk 108 and the fan 110 could be called target devices in the specification, because they will generate a large amount of heat during operating. The purpose of the fan 110 is to cool down these target devices. In an embodiment shown in FIG. 1, only the CPU 104 has a fan 110. But, in other embodiments not shown, the CPU 104, the memory 106 and the hard disk 108 may have their individual corresponding fan to enhance the efficiency of heat dissipation. In order to clearly describe the present invention, only the CPU 104 and a single fan 110 are used in the description. However, those skilled in the art may replace the CPU 104 with the memory 106, the hard disk 108, or any other target device, which may generate heat and need to be cooled in the computer system.

The fan 110 is preferably a fan using the duty cycle in PWM signal for control, such as the Freezer® fan provided by Arctic Cooling Corporation. However, in one embodiment, the fan 110 may also be an ordinary direct current (DC) fan. Accordingly, the invention should not be limited to the structure of the fan.

The current detector 112 provides a tiny resistance, such as 0.001 Ohm, for measuring the current I of the fan 110. The controller 116 may employ the current I to obtain the duty cycle in PWM signal for the fan 110. The skilled in the art may replace the CPU 104 with the memory 106, the hard disk 108 or any other target device in the computer system which will generate heat and need to be cooled, and measure the current of the fan actually providing heat-sink effect for these devices.

The ambient temperature sensor 114 is configured for detecting the temperature Te in the operating environment, i.e. room temperature, which is preferably installed outside the computer system 100. The ambient temperature sensor 114 may employ a conventional digital thermal sensor, and directly generate a digital signal corresponding to the detected ambient temperature. It should be noted that the ambient temperature sensor 114 and the CPU 104 should have appropriate distance therebetween to prevent the influence of heat generated by CPU 104 from the ambient temperature sensor 114.

The controller 116 comprises a microprocessor and memory (not shown), preferably integrated in BMC (Baseboard Management Controller) on a motherboard (not shown) of the computer system 100, such as VSC 452 BMC provided by Maxim Corp. or SE-SM4210-P01 BMC provided by ServerEngines Corporation. It should be noted that the controller 116 may also be implemented as an independent controller. In the embodiment, the controller 116 has an A/D port (not shown) for receiving the current I detected by the current detector 112. The controller 116 may also have other A/D port (not shown), which can receive the ambient temperature Te detected by the ambient temperature sensor 114. Furthermore, the controller 116 may also has a control signal output port for outputting a control signal to the fan 110, and further controlling the activation, stop or rotating speed of the fan 110.

For example, when the fan 110 is a PWM fan, the controller 116 can output a PWM signal with different duty cycles to control the fan 110. Furthermore, the memory of the controller 116 is stored with the firmware required for controlling the fan, and other associated parameters, such as Specific Heat Capacity/Density of air, sectional area of CPU 104 facing airflow of fan, threshold operating temperature Tm (Case Temperature) of CPU 104, or other parameters of CPU 104.

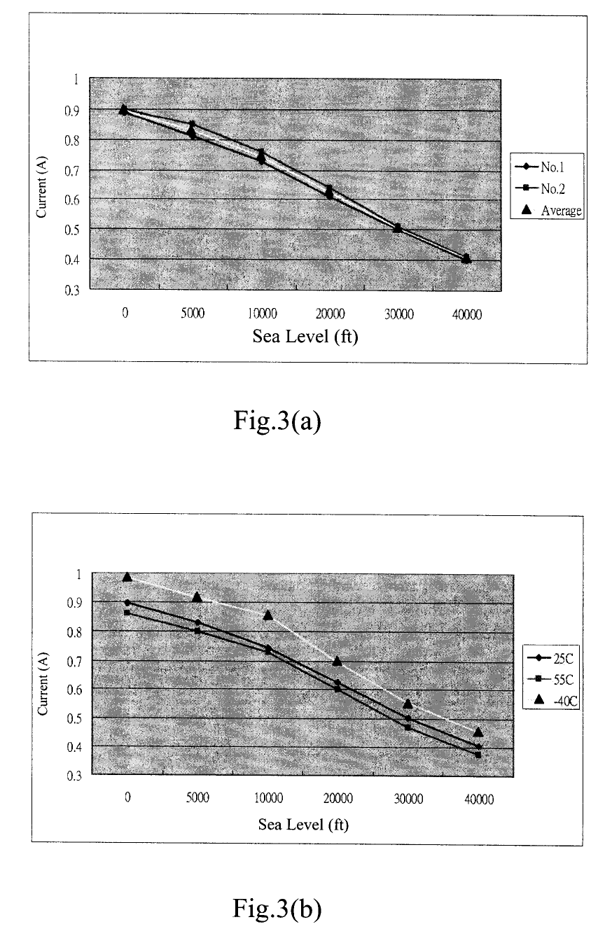

It should be noted that as the altitude of the position where the computer system is located increases, the air density is reduced so that the load of the fan is decreased, the fan speed is increased, and thus the current of the fan is decreased. FIG. 3(a) is a diagram showing a relationship of currents versus altitudes for two same kind of fans (i.e. No. 1 & No. 2) operating at 25° C., and a relationship of the average current (i.e. Average) of the two same fans versus altitude at 25° C. FIG. 3(b) is a diagram showing a relationship of the average currents of fans operating at the different temperatures (e.g. 25° C., 55° C., and −40° C.) versus altitudes. As illustrated, the current of the fan is negatively correlated with the altitude. That is, the altitude increases, and the current of the fan decreases.

The following will further describe how the controller 116 can determine the actual duty cycle outputting to the fan 110 at the different altitudes and at the different temperatures, so that the computer system can still operate normally and achieve the effect of energy saving. First, a nominal state is defined. In the conventional technique, if a computer system to operate normally at any altitudes is required, the fan speed of the computer system operating normally will be generally designed for a highest altitude specified by a system specification, such as 7000 ft from the sea level or much higher. In this embodiment, the nominal state is the one having the minimum duty cycle in PWM signal outputting to the fan at different ambient temperatures for a computer system operating normally at the specified highest altitude. At this time, a fan table as Table 1 may be created for a computer system by experiment at different ambient temperatures according to the preferred embodiment of the present invention. As shown in Table 1, each row shows a minimum duty cycle in PWM signal outputting to the fan for the computer system operating normally at each ambient temperature.

TABLE 1

| Ambient Temperature | PWM duty cycle (%) |
|---|---|
| 20 | 40 |
| 24 | 40 |
| 26 | 45 |
| 27 | 50 |
| 28 | 52 |
| 29 | 58 |
| 30 | 62 |
| 31 | 68 |
| 32 | 70 |
| 34 | 74 |
| 36 | 80 |
| 38 | 89 |
| 40 | 99 |

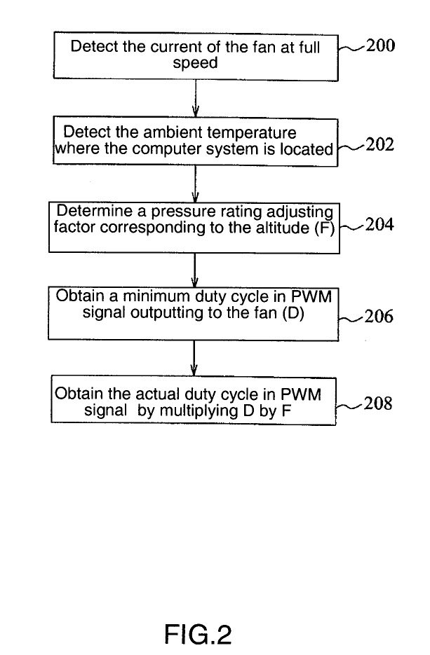

Next, the controller 116 will detect a current range of the fan at full speed when the computer system operates at the different altitudes. At this time, a pressure rating adjusting factor table as Table 2 may be created for a computer system by experiment at different ambient temperatures according to the preferred embodiment of the present invention. As shown in Table 2, the last row shows the pressure rating adjusting factor is “1” under the nominal state, that is, the computer system operates normally at the highest altitude specified by the system specification (such as 7000 ft from the sea level or much higher), and thus the minimum duty cycle in PWM signal outputting to the fan for the computer system operating normally will not need to be adjusted. Other rows show a minimum multiplication rating as a pressure rating adjusting factor for the minimum duty cycle in PWM signal so that the computer system operates normally when the measured fan current is within the current range of the fan at the altitude corresponding to the current range, so as to replace the function of the pressure sensor as a altitude sensor. The relationship between the pressure rating adjusting factor and the minimum duty cycle in PWM signal will be described in detail with reference to FIG. 2.

TABLE 2

| | Current range of fan at | Pressure rating adjusting |
|---|---|---|
| Altitudes(Ft) | full speed | factor (F) |
| 0-1000 | 0.89-0.85 | 0.83 |
| 1000-4000 | 0.85-0.82 | 0.9 |
| 4000-7000 | 0.82-0.77 | 0.95 |
| 7000-10000 | 0.77-0.73 | 1 |
| (nominal state) | | |

FIG. 2 shows a flow diagram for a fan control method of the present invention, which describes the present invention in connection with FIG. 1. In Step 200, when the computer system starts up, the current detector 112 detects the current of the fan at full speed at an altitude of the position where the computer system operates. In Step 202, the ambient temperature sensor 114 detects the ambient temperature where the computer system 100 is located. In Step 204, it is to determine a pressure rating adjusting factor corresponding to the altitude with reference to Table 2 according to the detected current. In Step 206, it is to obtain a minimum duty cycle in PWM signal outputting to the fan with reference to Table 1 for the computer system operating normally at the highest altitude specified by the system specification, i.e. the nominal state, according to the ambient temperature. In Step 208, the controller 116 can obtain the actual duty cycle in PWM signal outputting to the fan by multiplying the minimum duty cycle in PWM signal by the pressure rating adjusting factor corresponding to the altitude of the position where the computer system operates.

The above-mentioned CPU 104, memory 106 and hard disk 108 may have individually corresponding fans 110 to enhance the efficiency of heat dissipation. The skilled in the art can apply the embodiment of fan control method for CPU 104 for the corresponding fans of the memory 106, hard disk 108 or other target devices in the computer system which will generate heat and need to be cooled.

The present invention can be implemented with other specific form without departing from the spirit of the present invention or required features. The descriptions for said embodiments may only be treated by all means as explanatory, but not as limitation. Thus, the scope of the present invention is defined by the attached claims, but not by the above description. All the equivalent meanings falling within the claims and variations within the scope shall be construed as falling within the scope of claims.

1. A fan control system for a computer system, said computer system comprising
a fan for providing airflow to a target device of said computer system, said fan control system comprising
a current detector for detecting a current of said fan at full speed; and
a controller for generating a control signal for controlling said fan according to said current.

2. The fan control system of claim 1, wherein said fan of said computer system operates at full speed when startup.

3. The fan control system of claim 2, further comprising:
an ambient temperature sensor for detecting an ambient temperature where said computer is located;
wherein said controller controls said fan further according to said ambient temperature.

4. The fan control system of claim 1, wherein said control signal is a PWM signal.

5. The fan control system of claim 4, wherein said control stores a fan table, which comprises a duty cycle in PWM signal outputting to the fan at different ambient temperatures for a computer system operating normally at the specified highest altitude.

6. The fan control system of claim 5, wherein said control stores a pressure rating adjusting table, which comprises a minimum multiplication rating for said duty cycle in PWM signal outputting to the fan so that said computer system operates normally at the altitude corresponding to said current.

7. The fan control system of claim 6, wherein said control obtains an actual duty cycle in PWM signal at said ambient temperature outputting to said fan by multiplying said duty cycle in PWM signal by said pressure rating adjusting factor corresponding to the altitude of the position where said computer system operates

8. A computer system, comprising
a target device;
a fan to provide airflow to said target device; and
a fan control system, said fan control system comprising:
a current detector for detecting a current of said fan at full speed, and
a controller for generating a control signal for controlling said fan according to said current.

9. The computer system of claim 8, wherein said fan of said computer system operates at full speed when startup.

10. The computer system of claim 9, wherein said fan control system further comprising:
an ambient temperature sensor for detecting an ambient temperature where said computer is located;
wherein said controller controls said fan further according to said ambient temperature.

11. The computer system of claim 8, wherein said control signal is a PWM signal.

12. The computer system of claim 11, wherein said target device is a CPU.

13. The computer system of claim 12, further comprising a Baseboard Management Controller (BMC), wherein said controller of said fan control system is integrated in said BMC.

14. The computer system of claim 11, wherein said control stores a fan table, which comprises a duty cycle in PWM signal outputting to the fan at different ambient temperatures for a computer system operating normally at the specified highest altitude.

15. The computer system of claim 14, wherein said control stores a pressure rating adjusting table, which comprises a minimum multiplication rating for said duty cycle in PWM signal outputting to the fan so that said computer system operates normally at the altitude corresponding to said current.

16. The computer system of claim 15, wherein said control obtains an actual duty cycle in PWM signal at said ambient temperature outputting to said fan by multiplying said duty cycle in PWM signal by said pressure rating adjusting factor corresponding to the altitude of the position where said computer system operates.

17. A fan controlling method for a computer system, said computer system comprising a fan for providing airflow to a target device of said computer system, said method comprising:
detecting a current of said fan at full speed; and
generating a control signal for controlling said fan according to said current.

18. The method of claim 17, wherein said fan of said computer system operates at full speed when startup.

19. The method of claim 18, wherein said fan control system further comprising:
an ambient temperature sensor for detecting an ambient temperature where said computer is located;
wherein said controller controls said fan further according to said ambient temperature.

20. The method of claim 17, wherein said control signal is a PWM signal.
